(19) United States
(12) Patent Application Publication
(10) Pub. No.: US 2012/0225985 A1
(43) Pub. Date: Sep. 6, 2012

(54) NANO WIDE COLOR GEMUT TRANSPARENT ENVIRONMENT-FRIENDLY INKJET INK COMPOSITION

(75) Inventors: Cheng-Yang Hsieh, Taichung City (TW); Cheng-Lin Liang, Taichung City (TW)

(73) Assignee: TAIWAN NANOTECHNOLOGY CORPORATION, Taichung (TW)

(21) Appl. No.: 13/240,312

(22) Filed: Sep. 22, 2011

(30) Foreign Application Priority Data
Mar. 4, 2011 (TW) 100107398

(51) Int. Cl. C08K 5/101; B82Y 30/00

(52) U.S. Cl. 524/315; 977/773

(57) ABSTRACT

A nano wide color gamut transparent environment-friendly inkjet ink composition used on a base, which comprises color paste, mixed solvent, resin and additive. The color paste is used for polymerizing red toner, yellow toner, blue toner and black toner having nanoparticles. The mixed solvent is used for diluting the ink composition and being a carrier of the ink composition. The resin is used for providing drip-drying, dispersity and glossiness of the ink composition. The ink composition of the invention can be used to achieve high permeability, wide color gamut, drip drying, low ink bleeding, and high resolution.

### FIELD OF THE INVENTION

The present invention relates to a nano wide color gamut transparent environment-friendly inkjet ink composition, and particularly to an environment-friendly inkjet ink composition used on a hard base.

### BACKGROUND

In conventional technology, inkjet ink can be categorized according to its composition as aqueous ink, solvent-based ink and ultraviolet curing ink. Aqueous ink is characterized for its low cost, pollution free and glowing color, but its major component is water, which volatiles slowly and is difficult to drip-dry and soak into the base material. Thus, it is generally used on a base such as paper and fiber (cloth) based material with coating.

Furthermore, aqueous ink is not known for its weather-proof characteristics and is generally used indoors; thus, solvent-based ink is generally used in outdoor environments. The major component of solvent-based ink is generally an organic solvent (for example, a mixed solvent of ester and ketone materials), and it is generally used on polyvinyl chloride (PVC) pastes or PVC canvas. In the combination process to the base, the ink performs swelling and fusing on the base to combine the colorant in the ink to the base, so there is no need to have coatings on the PVC base, and the ink can attach firmly on the base and allow high-speed printing requirements. However, the solvent-based ink has the defect that it is only applicable on the PVC base which allows swelling, and inapplicable on other bases that do not swell. Furthermore, when the solvent-based ink is used on transparent bases (such as light boxes where transparent materials are required), the permeability is generally low due to the lower color contrast of the toners of the ink, which results in low brightness and glossiness. Thus, conventional solvent-based ink is not known for its industrial applicability.

Therefore, in view of the aforementioned conventional problems, there is a need for an ink combination to solve the aforementioned problems.

### SUMMARY OF THE INVENTION

An objective of the present invention is to provide a nano wide color gamut transparent environment-friendly inkjet ink composition, which utilizes color paste with nanometer (1 nm=10⁻⁹ m) to achieve high permeability.

Another objective of the present invention is to provide a nano wide color gamut transparent environment-friendly inkjet ink composition, which utilizes color paste with a plurality of toners to achieve wide color gamut (WCG).

A further objective of the present invention is to provide a nano wide color gamut transparent environment-friendly inkjet ink composition, which can be used on hard base materials (such as glass, acrylics, ceramic tiles, metal materials), and the ink composition can be directly applied on the base material without altering the base material coating or changing the base material.

Another objective of the present invention is to provide a nano wide color gamut transparent environment-friendly inkjet ink composition, where the ink composition can be quickly dried after being applied on the base.

A further objective of the present invention is to provide a nano wide color gamut transparent environment-friendly inkjet ink composition, which provides low surface tension on the base material to achieve ink flattening.

To achieve the foregoing objectives of the invention, the invention provides a nano wide color gamut transparent environment-friendly inkjet ink composition used on a base, which comprises color paste, mixed solvent, resin and additive. The color paste is used for polymerizing red toner, yellow toner, blue toner and black toner having nanoparticles. The mixed solvent is used for diluting the ink composition and being a carrier of the ink composition. The resin is used for providing drip-drying, dispersity and glossiness of the ink composition.

Comparing to the conventional technology, the nano wide color gamut transparent environment-friendly inkjet ink composition of the present invention can achieve wide color gamut of at least RYBK colors by the combination of the plurality of color toners with specific color codes. Furthermore, the size of the toners are in the range of nanometers (smaller than 300 nm) so that the ink composition has high permeability. Furthermore, when the ink composition of the present invention is applied on the base, it provides low surface tension on the base material such that the ink composition flat attaches on the base, which comprises a hard base material. Thus, the ink composition of the invention can be used to achieve high permeability, wide color gamut, drip drying, low ink bleeding, and high resolution.

### BRIEF DESCRIPTION OF THE DRAWINGS

FIG. 1 is a schematic view of color gamut of an embodiment of the nano wide color gamut transparent environment-friendly inkjet ink composition of the present invention;

FIG. 2 is a schematic view of chemical formulation of propylene glycol monomethyl ether used in an embodiment of the nano wide color gamut transparent environment-friendly inkjet ink composition of the present invention;

FIG. 3 is a schematic view of chemical formulation of diethylene glycol dimethyl ether used in an embodiment of the nano wide color gamut transparent environment-friendly inkjet ink composition of the present invention; and

FIG. 4 is a schematic view of chemical formulation of acrylic resin used in an embodiment of the nano wide color gamut transparent environment-friendly inkjet ink composition of the present invention.

### DETAILED DESCRIPTION OF THE INVENTION

The techniques employed by the present invention to achieve the foregoing objectives, characteristics and effects thereof are described hereinafter by way of examples with reference to the accompanying drawings.

The invention provides a nano wide color gamut transparent environment-friendly inkjet ink composition used on a base, which comprises color paste, mixed solvent, resin and additive.

The material of the base can be hard materials of polyvinyl butyral (PVB), polyvinyl chloride (PVC), polyethylene terephthalate (PET), acrylics, plastic, acrylonitrile butadiene styrene (ABS), polycarbonate (PC), glass, metal or ceramic tiles.

The color paste is used for polymerizing red (R) toner, yellow (Y) toner, blue (B) toner and black (K) toner having nanoparticles, and the color paste comprising the toners can be referred to as RYBK paste. The size of the nanoparticles is smaller than 300 nanometers, and in another embodiment, the size of the nanoparticles can be between 50 nanometers and 100 nanometers. The color code of the red (R) toner can be at least one of R-177, R-254 and R-242. The color code of the yellow (Y) toner can be at least one of Y-120, Y-139 and Y-150. The color code of the blue (B) toner can be B15:6. The color code of the black (K) toner can be BK-7. Basic physical characteristics of the toners are listed in the following table:

| | Surface | Solidi- | Viscos- | Den- | | | |
|---|---|---|---|---|---|---|---|
| | tension | fication | ity | sity | CIE color tone | | |
| Toner | (mN/m) | (%) | (cP) | (g/mL) | x | y | Y |
| Red | 23.2 | 22.81 | 3.57 | 1.0287 | 0.4494 | 0.2654 | 27.913 |
| (R) | | | | | | | |
| toner | | | | | | | |
| Yel- | 22.3 | 21.62 | 6.04 | 0.9825 | 0.4156 | 0.4905 | 92.12 |
| low | | | | | | | |
| (Y) | | | | | | | |
| toner | | | | | | | |
| Blue | 22.3 | 21.36 | 6.03 | 0.97 | 0.1723 | 0.2114 | 37.494 |
| (B) | | | | | | | |
| toner | | | | | | | |
| Black | 21.9 | 21.43 | 5.92 | 0.9794 | 0.3845 | 0.3768 | 7.853 |
| (K) | | | | | | | |
| toner | | | | | | | |

Furthermore, the color paste further comprises polymerized green toner, and the color code of the green toner can be at least one of G-7, G-36 and G-58.

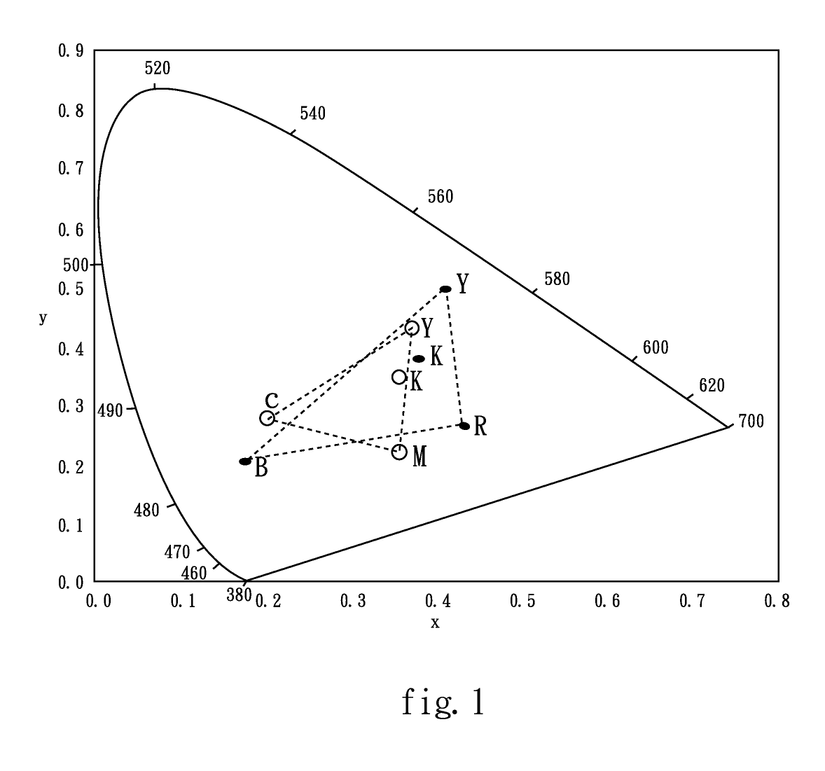

In addition, the color gamut of the color paste is shown in FIG. 1. The color gamut is obtained by various combinations of the toners of the specific color codes, which result in a much wider color gamut than that in the conventional technology, so that the ink composition shows glossy color. In FIG. 1, the conventional ink is shown by the CMYK (4 printing colors) color gamut, and the ink composition of the present invention is shown by the RYBK color gamut. The color gamut of the ink composition of the present invention is obviously wider than the color gamut of the conventional ink.

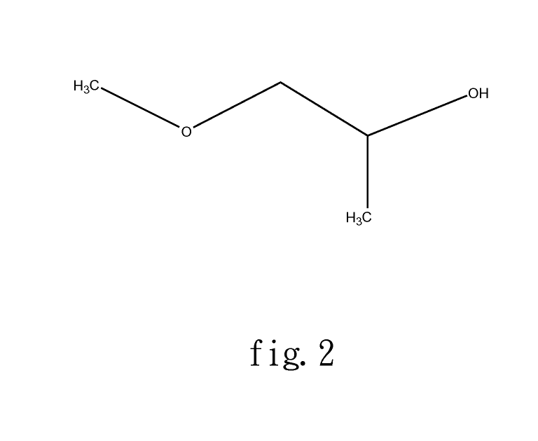

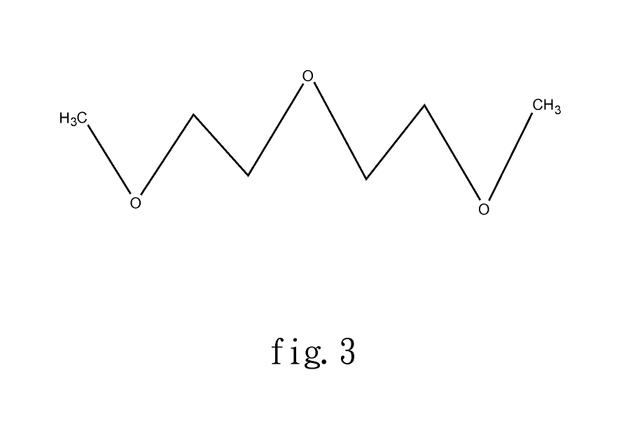

The mixed solvent is used for diluting the ink composition and being a carrier of the ink composition. The type and the quantity of ingredients of the mixed solvent greatly affect the stability of the ink composition. The mixed solvent should be obtained by choosing from organic solvents such as low boiling point alcohol, high boiling point alcohol, ether, heterocyclic amine, and cyclic ester, and selecting the best combination for the ink such that stability, viscosity, surface tension and conductivity of the ink composition fit the commercial requirements of the ink composition. In an embodiment, the mixed solvent is selected from a group consisting of ethyl acetate, butyl acetate, and isopropyl acetate. For example, the mixed solvent can be propylene glycol monomethyl ether, and its chemical formulation is shown in FIG. 2; alternatively, the mixed solvent can be diethylene glycol dimethyl ether, and its chemical formulation is shown in FIG. 3.

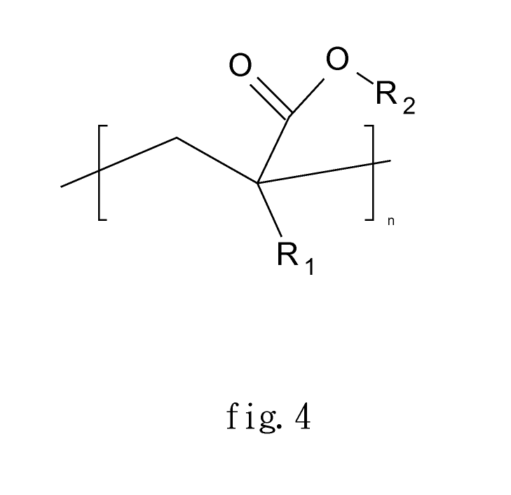

The resin is used to disperse the ink composition for providing drip-drying, dispersity and glossiness of the ink composition. For example, the resin can be selected from a group consisting of acrylic resin, resin, epoxide resin, saturated polyester resin, and alkyd resin. In an embodiment, the resin is acrylic resin, and its chemical formulation is shown in FIG. 4.

The additive can further comprise at least one of emulsifier, surfactant, and ultraviolent absorbent. The emulsifier has significant surface activity to form surface films around fluid drops, create electric barriers on the surface of fluid drops, and increase viscosity of the surface. The emulsifier also provides stability for the ink composition in relation to acids, alkalis and salts, and is not irritable.

The emulsifier can further comprises surfactant, which refers to substances reducing the surface tension of the ink composition and reducing surface tension between two fluids. The surfactant can be organic amphiphilic molecules with hydrophilic and hydrophobic groups, which is dissolvable to organic solution and water solution. In addition to reduce the surface tension of the ink composition, the surfactant also provides functions such as lubricating, permeating, dispersing, emulsifying, and purifying. The surfactant can be comprised of ionic surfactant, nonionic surfactant, and amphoteric surfactant. The ionic surfactant can be further categorized as cationic surfactant and anionic surfactant.

The ultraviolent absorbent (also referred to as light stabilizer) can be plural recipe type, and particularly plural recipes using benzyl benzoate, phenyl ketone, or benzotrizole instead of acrylonitrile, triasine and hindered amine groups such that the ultraviolent absorbent is easier to achieve ideal ultraviolent absorbing than single recipe ultraviolent absorbent. Furthermore, the ultraviolent absorbent is provided so that the ink composition would not easily be decomposed or allochroic.

Furthermore, in the nano wide color gamut transparent environment-friendly inkjet ink, the surface tension of the ink composition can be 22-24 N/m. With the recipe, a realistic glossy and wide gamut can be obtained, and the color performance would be much preferable. The ink would be waterproof and sustained to wear and tear, and has great dispersity and is ultraviolet-proof from color fading. Also, the ink does not contain poisonous solvent such as benzene, toluene, xylene or cyclohexanone, and has good attaching and drip drying characteristics.

Comparing to the conventional technology, the nano wide color gamut transparent environment-friendly inkjet ink composition of the present invention can achieve wide color gamut of at least RYBK colors by the combination of the plurality of color toners with specific color codes. Furthermore, the size of the toners is in the range of nanometers (smaller than 300 nm) so that the ink composition has high permeability. Furthermore, when the ink composition of the present invention is applied on the base, it provides low surface tension on the base material such that the ink composition flat attaches on the base, which comprises a hard base material. Thus, the ink composition of the invention can be used to achieve high permeability, wide color gamut, drip drying, low ink bleeding, and high resolution.

The preferred embodiments of the present invention have been disclosed in the examples. However, the examples should not be construed as a limitation on the actual applicable scope of the invention, and as such, all modifications and alterations without departing from the spirits of the invention and appended claims shall remain within the protected scope and claims of the invention.

What is claimed is:

1. A nano wide color gamut transparent environment-friendly inkjet ink composition used on a base, comprising:
color paste for polymerizing red toner, yellow toner, blue toner and black toner having nanoparticles ;
mixed solvent for diluting the ink composition and being a carrier of the ink composition;
resin for providing drip-drying, dispersity and glossiness of the ink composition; and
additive.

2. The nano wide color gamut transparent environment-friendly inkjet ink composition as claimed in claim 1, wherein the mixed solvent is selected from a group consisting of ethyl acetate, butyl acetate, and isopropyl acetate.

3. The nano wide color gamut transparent environment-friendly inkjet ink composition as claimed in claim 2, wherein the mixed solvent comprises at least one of propylene glycol monomethyl ether and diethylene glycol dimethyl ether.

4. The nano wide color gamut transparent environment-friendly inkjet ink composition as claimed in claim 1, wherein the additive further comprises at least one of emulsifier, surfactant, and ultraviolent absorbent.

5. The nano wide color gamut transparent environment-friendly inkjet ink composition as claimed in claim 1, wherein the color code of the red toner is at least one of R-177, R-254 and R-242.

6. The nano wide color gamut transparent environment-friendly inkjet ink composition as claimed in claim 1, wherein the color code of the yellow toner is at least one of Y-120, Y-139 and Y-150.

7. The nano wide color gamut transparent environment-friendly inkjet ink composition as claimed in claim 1, wherein the color code of the blue toner is B15:6.

8. The nano wide color gamut transparent environment-friendly inkjet ink composition as claimed in claim 1, wherein the color code of the black toner is BK-7.

9. The nano wide color gamut transparent environment-friendly inkjet ink composition as claimed in claim 1, wherein the color paste further comprises polymerized green toner, and the color code of the green toner is at least one of G-7, G-36 and G-58.

10. The nano wide color gamut transparent environment-friendly inkjet ink composition as claimed in claim 1, wherein surface tension of the ink composition is 22-24 N/m.

11. The nano wide color gamut transparent environment-friendly inkjet ink composition as claimed in claim 1, wherein material of the base is hard material of polyvinyl butyral (PVB), polyvinyl chloride (PVC), polyethylene terephthalate (PET), acrylics, plastic, acrylonitrile butadiene styrene (ABS), polycarbonate (PC), glass, metal or ceramic tiles.

12. The nano wide color gamut transparent environment-friendly inkjet ink composition as claimed in claim 1, wherein size of the nanoparticles is smaller than 300 nanometers.

13. The nano wide color gamut transparent environment-friendly inkjet ink composition as claimed in claim 12, wherein size of the nanoparticles is between 50 nanometers and 100 nanometers.

14. The nano wide color gamut transparent environment-friendly inkjet ink composition as claimed in claim 1, wherein the resin is selected from a group consisting of acrylic resin, resin, epoxide resin, saturated polyester resin, and alkyd resin.

15. The nano wide color gamut transparent environment-friendly inkjet ink composition as claimed in claim 14, wherein the resin is acrylic resin.
